(19) United States
(12) Patent Application Publication
(10) Pub. No.: US 2024/0165719 A1
(43) Pub. Date: May 23, 2024

(54) ARRANGEMENT COMPOSED OF AT LEAST ONE DRILL BIT AND AT LEAST ONE LIMIT STOP

(71) Applicant: Tyrolit Schleifmittelwerke Swarovski AG & Co K.G., Schwaz (AT)

(72) Inventors: Georg DAXER, Eben am Achense (AT); Thomas NOESSLER, Buch in Tirol (AT)

(21) Appl. No.: 18/511,436

(22) Filed: Nov. 16, 2023

(30) Foreign Application Priority Data
Nov. 17, 2022 (AT) A 50871/2022

(51) Int. Cl. B23B 51/04

(52) U.S. Cl. CPC B23B 51/04

(57) ABSTRACT

An arrangement includes at least one drill bit and at least one limit stop for a drilling core, or parts of a drilling core, forming in the course of drilling. The at least one limit stop has at least one fluid opening transverse to an axis of rotation of the at least one drill bit, and the at least one limit stop has a central through-hole for receiving a centering pin.

### BACKGROUND OF THE INVENTION

The present invention relates to an arrangement and a drilling machine with at least one fluid-conducting portion, at least one such arrangement and a fastening device for fastening the drill bit or the arrangement to the drilling machine. Furthermore, the invention relates to a method for machining a workpiece by means of at least one such arrangement.

The state of the art includes EP 3 144 099 B1. An insert for a drilling machine is disclosed therein. This insert can also be referred to as a drilling core stopper or drilling core spacer and is used to keep suction openings clear, even when a drilling core breaks off and is sucked in by an air cooling system. In application, a drill bit is fastened onto the external thread of a drive shaft of a drilling machine. In contrast, the insert is screwed into the drive shaft. For this it is necessary for the drive shaft to have an internal thread.

However, various disadvantages arise in this state of the art.

One disadvantage is that the insert, drilling core stopper or drilling core spacer cannot be used in every drilling machine from every manufacturer since some drilling machines do not have an internal thread and thus it is not possible to fasten a further means besides the drill bit to the drive shaft. This means that the possible uses of an insert according to the state of the art are limited.

A further disadvantage is that a centering pin is often used for the “initial drilling”, in order to position the drill bit exactly at the desired site. Such a centering pin is fitted in the drive shaft for this purpose. When using a centering pin it is thus no longer possible to additionally fasten an insert according to the state of the art in the drive shaft.

In this case, during the “initial drilling”, the centering pin must be fitted in the drive shaft and the drill bit must be fastened onto the drive shaft, in order to dismantle the drill bit after the “initial drilling”, to remove the centering pin, to fit the insert in the drive shaft and to fasten the drill bit again. There are thus many working steps, which are time-intensive, user-unfriendly and/or, due to contamination of the parts, for example through dust-soiled thread turns, difficult to carry out. In this case, the possible uses of an insert and a further means such as a centering pin are limited.

As already explained above, firstly a drive shaft with an internally arranged fastening means, such as for example an internal thread, is necessary in order to be able to use an insert at all. Secondly, when an internal thread of a drive shaft of a drilling machine is present, the use of a centering pin and an insert according to the state of the art is only possible when either one means or the other is used during drilling. Simultaneous use is impossible.

### SUMMARY OF THE INVENTION

The object of the present invention is to at least partially remedy the disadvantages of the state of the art and to specify an arrangement which is improved compared with the state of the art and is characterized in particular by an improved ease of use and/or extended possible uses. The object is furthermore to specify a drilling machine with an arrangement improved in such a way and a method for machining a workpiece by means of at least one arrangement improved in such a way.

This object is achieved according to a first aspect of the invention by providing an arrangement composed of at least one drill bit and at least one limit stop for a drilling core, or parts of a drilling core, forming in the course of drilling. The at least one limit stop has at least one fluid opening transverse to an axis of rotation of the at least one drill bit, and the at least one limit stop has a central through-hole for receiving a centering pin.

Through the central through-hole of the limit stop, a centering pin or another means can thus be fastened through the central through-hole of the simultaneously fitted limit stop.

In this way, it is possible to use both a limit stop, which acts as drilling core stopper or as drilling core spacer, and at the same time a centering pin, which makes it possible to position the drilling core during the “initial drilling”. The possible uses are thus extended.

According to a second aspect of the invention, the at least one drill bit and the at least one limit stop form a coherent structural unit.

When drill bit and limit stop form a coherent structural unit, the working step in which the limit stop which acts as drilling core stopper or as drilling core spacer must be separately fastened and detached again is omitted. This means that, instead of removing and fastening the drill bit and the limit stop in two working steps each, only one working step is necessary according to the second aspect of the invention. The ease of use is thus improved.

In this way, the risk of contamination at the connection point between the drill bit and the limit stop is also reduced, as a result of which more difficult fitting, damage to the parts and/or workplace accidents can be avoided and/or prevented.

By “transverse to an axis of rotation of the at least one drill bit” is meant here that the course of the at least one fluid opening deviates from the axis of rotation of the at least one drill bit.

In other words, this means that the line of the course of the at least one fluid opening is inclined relative to the axis of rotation of the at least one drill bit at an angle which deviates from 0°.

It is conceivable that the at least one fluid opening leads to a further opening and/or drilled hole and/or recess, which is oriented parallel to the axis of rotation of the at least one drill bit. In this case, the course of the at least one fluid opening is still transverse to an axis of rotation of the at least one drill bit.

Preferably, the at least one fluid opening is formed as a fluid connection, preferably a gas connection, between the drill bit and the drilling machine.

Particularly preferably, the at least one fluid opening can be a fluid inlet opening and/or a fluid outlet opening. For example, in dry drilling operation the fluid opening can be a fluid inlet opening into the drill bit for the ambient air or a fluid outlet opening out of the drill bit for the cooling air. In another example, in wet drilling operation the fluid opening can be a fluid inlet opening into the drill bit for a cooling medium or a fluid outlet opening out of the drill bit for a cooling medium.

Through the at least one fluid opening running transverse to an axis of rotation of the at least one drill bit, a fluid connection, preferably a gas connection, between the drill bit and the drilling machine can preferably remain protected, even when a drilling core, or parts of a drilling core, forming in the course of drilling break off, are sucked in by the at least one fluid opening and strike the limit stop.

According to a preferred embodiment of the arrangement, the at least one drill bit comprises:
a substantially hollow-cylindrical drill bit body and/or
at least one cutting device arranged at one end of the at least one drill bit and/or
at least one closure device, in particular an end cap, arranged toward one, preferably the other, end of the at least one drill bit and/or
a drill bit receiving device arranged toward one, preferably the other, end of the at least one drill bit, wherein the drill bit receiving device has
   a fitting mechanism for making contact with a fitting tool, preferably an angular portion, particularly preferably a hexagon head, and/or
   a drill bit fastening mechanism for fastening the drill bit to a drilling machine, preferably to a drive shaft of a drilling machine, preferably wherein, for fastening the drill bit to a drilling machine, the drill bit fastening mechanism is a thread, particularly preferably an internal thread.

The substantially hollow-cylindrical drill bit body and the at least one cutting device arranged thereon determine the contour and the shape of the drilled hole. In another embodiment, the at least one cutting device can be part of the at least one drill bit. In other words, the substantially hollow-cylindrical drill bit body has cutting elements.

The fitting device for receiving a fitting tool can be a hexagon head as usual. In this case, the fitting tool can be a wrench. Other fitting tools are also conceivable, wherein, in the broadest sense, a manual fitting without a dedicated tool is also conceivable.

The drill bit fastening mechanism, which is used for fastening the drill bit to the drilling machine, can be an internal thread as usual, which can be fitted onto the external thread of the drive shaft of the drilling machine. It is also possible to fasten the drill bit to an internal thread of the drive shaft of the drilling machine using the drill bit fastening mechanism. It is also possible to provide a different type of fastening instead of a thread.

According to a preferred embodiment of the arrangement, the at least one drill bit and/or the at least one limit stop consist and/or consists of one component and/or of a multi-part component assembly, wherein the component assembly can be connected detachably and/or non-detachably.

An advantage of a one-part arrangement composed of drill bit and limit stop can be that it can be a particularly stable and robust arrangement. In the case of a component assembly, the limit stop can be non-detachably connected to the drill bit, for example by a welded connection, which can also result in a robust arrangement and can additionally provide advantages for manufacturing reasons. In contrast, if the component assembly is formed detachable, the possibility of using different limit stops for different drill bits presents itself, which expands the possible uses even further.

In a preferred embodiment variant, the at least one drill bit represents a multi-part component assembly composed of the substantially hollow-cylindrical drill bit body, the at least one cutting device, the at least one closure device, the at least one drill bit receiving device.

In a preferred embodiment variant, the substantially hollow-cylindrical drill bit body is non-detachably connected to the closure device by a welded connection.

In a preferred embodiment variant, the closure device is detachably connected to the drill bit receiving device.

In a preferred embodiment variant, the at least one limit stop is part of the drill bit receiving device and thus the at least one limit stop and the drill bit receiving device represent one component.

According to a preferred embodiment of the arrangement, the at least one limit stop has at least one limit stop point and/or at least one limit stop line and/or at least one limit stop surface, preferably at least two limit stop surfaces, particularly preferably exactly four limit stop surfaces, preferably wherein the at least one limit stop line and/or the at least one limit stop surface are aligned transverse to an axis of rotation of the at least one drill bit, particularly preferably wherein the at least one limit stop line and/or the at least one limit stop surface are aligned substantially perpendicular to an axis of rotation of the at least one drill bit.

By “substantially perpendicular” is meant here that the angle between two elements lies close to 90°, preferably between 45° and 135°, particularly preferably between 70° and 110°.

The use of limit stops in the form of a point, a line and/or a surface, offers the possibility of preparing to the risk of a broken-off drilling core or parts of a drilling core even more flexibly in advance. For example, a non-brittle drilling core can be adequately stopped by limit stops with a small limit stop site, such as in the case of limit stop points or limit stop lines. However, if a brittle material is involved, where the drilling core shatters easily, one or more large limit stop surfaces may be preferred.

In a preferred embodiment variant, the same or a different number of limit stop points and/or limit stop lines and/or limit stop surfaces are combined with one another.

In a preferred embodiment variant, the limit stop lines and/or limit stop surfaces present can have the same or different shapes. For example, a limit stop line may be straight and/or curved. Limit stop surfaces may, for example, be angular and/or round and/or flat, in other words even, and/or wavy, in other words uneven, hilly, rough.

According to a preferred embodiment of the arrangement, the at least one fluid opening is arranged substantially perpendicular to the axis of rotation of the at least one drill bit.

If the at least one fluid opening is substantially perpendicular to the axis of rotation of the at least one drill bit, then the risk of the at least one fluid opening being closed by a drilling core or parts of a drilling core is lower.

According to a preferred embodiment of the arrangement, the at least one fluid opening has a round and/or an angular cross section and is delimited by at least one contour surface of the at least one limit stop.

It can be advantageous, for example, to produce the at least one fluid opening in the limit stop by drilling or by milling or by another manufacturing process. Depending on the preferred application and production, a round drilled hole or an angular and milled groove or a fluid opening produced by a different manufacturing process is thus preferred.

According to a preferred embodiment of the arrangement, the central through-hole, for receiving a centering pin, of the at least one limit stop is concentric with the axis of rotation of the at least one drill bit.

Through the concentric arrangement, imbalances and thus the risk of injury and possible damage can be prevented.

In a preferred embodiment, the central through-hole, for receiving a centering pin, of the at least one limit stop is larger than or the same as the diameter of the internal thread of the drive shaft of the drilling machine, particularly preferably larger than or the same as the diameter of the external thread of the drive shaft of the drilling machine.

Protection is furthermore sought for a drilling machine with at least one fluid-conducting portion, preferably at least one air-suction portion, at least one arrangement according to the first and/or second aspect according to the invention, and a drilling machine fastening mechanism for fastening the drill bit or the arrangement according to the invention to the drilling machine. Preferably the drill bit has a drill bit fastening mechanism for fastening the drill bit to a drilling machine, preferably to a drive shaft of a drilling machine. Preferably, for fastening the drill bit to a drilling machine, the drill bit fastening mechanism is a thread, particularly preferably an internal thread, and the drilling machine fastening mechanism has a counter-fastening mechanism, corresponding to the drill bit fastening mechanism of the drill bit, which is preferably formed as an external thread.

Through such a drilling machine, an arrangement according to the invention for drilling can be used, in which the at least one fluid-conducting portion of the drilling machine is not closed by a drilling core, or parts of a drilling core, forming in the course of the drilling, and an increased ease of use is achieved before, during and/or after the drilling.

Further advantageous embodiments of the drilling machine with at least one arrangement according to the first and/or second aspect according to the invention are described below.

According to a preferred embodiment of the drilling machine, the at least one fluid-conducting portion, preferably the at least one air-suction portion, is in or can be brought into a fluid connection with a connector for a suction device.

The suction device can be a vacuum cleaner, for example, which can be brought into contact with the drilling machine in order to suction off drilling dust forming during the drilling.

In a preferred embodiment variant, the suction device can cool the drilled hole and the parts used with the help of the suctioned fluid, for example air or another cooling agent.

According to a preferred embodiment of the drilling machine, the at least one fluid-conducting portion, preferably the at least one air-suction portion, and/or the drilling machine fastening mechanism are formed in and/or on a drill adaptor that can preferably be detachably connected to the drilling machine.

Through the use of the drill adaptor, the possible uses can be even further expanded since different drilling machines, for example without an integrated fluid-conducting portion, can be used with the arrangement.

According to a preferred embodiment of the drilling machine, a fixing mechanism for detachably fixing a further part, preferably a centering pin or a drill, particularly preferably a center drill, is provided on the drilling machine, preferably wherein the fixing mechanism is formed for detachably fixing a further part in and/or on a drill adaptor that can preferably be detachably connected to the drilling machine, and preferably wherein the fixing mechanism has an internal thread.

Through this particularly preferred embodiment variant, besides the arrangement, including the limit stop, a further part, such as a centering pin, can be used at the same time during a partial drilling.

According to a preferred embodiment of the drilling machine, the at least one fluid opening is formed as a fluid connection, preferably a gas connection, between the drill bit and the at least one fluid-conducting portion, preferably the at least one air-suction portion.

In this way, drilling dust and/or air can be discharged continuously from the void volume of the arrangement, specifically the void volume of the drill bit, as far as the at least one fluid-conducting portion, preferably even further to a suction device.

Besides the arrangement and the drilling machine per se, the invention also relates to a method for machining a workpiece by means of at least one arrangement according to the first and/or second aspect according to the invention.

According to a first aspect of a method for machining a workpiece by means of at least one arrangement according to the invention the at least one limit stop has a central through-hole for receiving a centering pin. In a first method step, a centering pin is arranged in the at least one through-hole and a partial drilling of the workpiece is performed, and in a second method step the centering pin is removed and the partial drilling of the workpiece is continued.

Through the first aspect of the method, a partial drilling can be performed with a centering pin with an increased ease of use and then continued without the centering pin with little retooling effort.

According to a second aspect of a method for machining a workpiece by at least one arrangement according to the invention the at least one drill bit and the at least one limit stop form a coherent structural unit. The structural unit is detachably fastened to a drive shaft of a drilling machine before and/or after a drilling of the workpiece is carried out.

Through the second aspect of the method, a drilling can be carried out wherein only one structural unit needs to be fastened beforehand, instead of fastening a drill bit and a limit stop separately and one after the other.

In a preferred embodiment of a method for machining a workpiece by at least one arrangement according to the invention, the method is suitable for drilling holes in metal, in particular steel girders, asphalt, concrete, reinforced concrete, masonry, in particular brick walls, stone, in particular rock and/or mineral soils, and/or subsoil.

In a preferred embodiment of a method for machining a workpiece by at least one arrangement according to the invention, the method is suitable for drilling holes in dry drilling use and/or in wet drilling use.

### BRIEF DESCRIPTION OF THE DRAWINGS

Further details and advantages of preferred embodiments of the invention are explained in more detail below with the aid of the description of the figures with reference to the drawings, in which:

FIG. 1: shows an arrangement according to the invention composed of a drill bit and a limit stop;

FIG. 2: is a top view of the arrangement from FIG. 1;

FIG. 3: shows drill bit receiving device with the limit stop from FIG. 1;

FIG. 4: is a top view of the drill bit receiving device with a limit stop from FIG. 3;

FIG. 5: is a bottom view of the drill bit receiving device with a limit stop from FIG. 3;

FIG. 6: is a perspective view of the arrangement from FIG. 1;

FIG. 7: is a schematic representation of a drilling machine with an arrangement according to the invention;

FIG. 8: is a schematic representation of the drilling machine from FIG. 7 with a centering pin; and

FIG. 9: is a schematic representation of the drilling machine from FIG. 7 with a drilling core forming in the course of drilling.

### DETAILED DESCRIPTION OF THE INVENTION

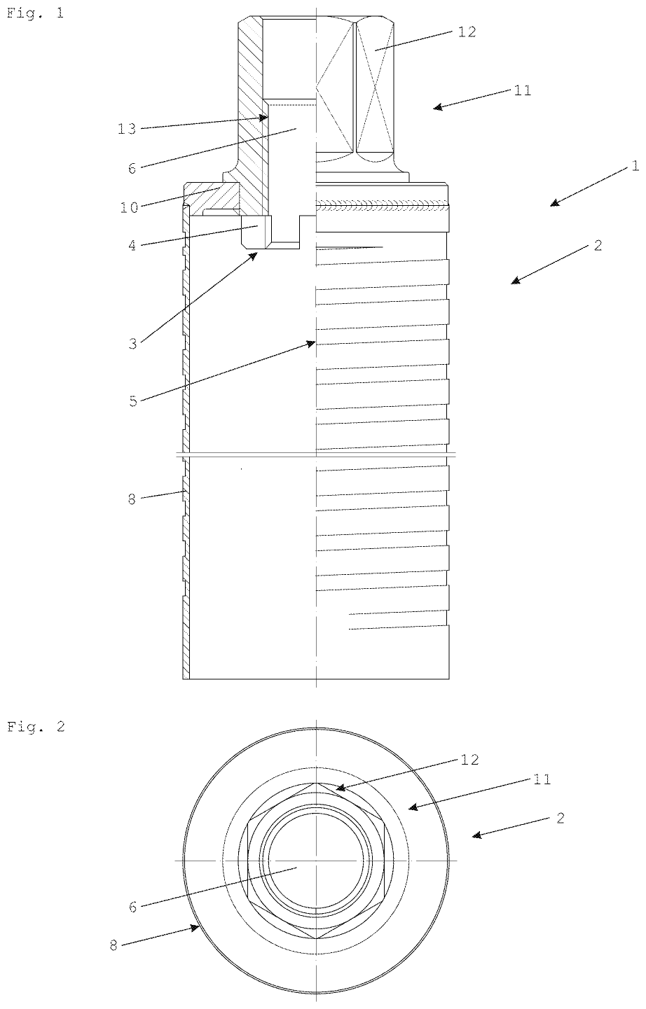

FIG. 1 shows an arrangement 1 according to the invention composed of a drill bit 2 and a limit stop 3.

Half of the representation in FIG. 1 is depicted as a sectional representation with a section plane running through the middle of the arrangement 1 and the other half is depicted as a normal, non-sectional representation.

The arrangement 1 can include at least one drill bit 2 and at least one limit stop 3 for a drilling core 22, or parts of a drilling core 22, forming in the course of drilling, wherein the at least one limit stop 3 has at least one fluid opening 4 transverse to an axis of rotation 5 of the at least one drill bit 2, wherein the at least one limit stop 3 has a central through-hole 6 for receiving a centering pin 7.

A central through-hole 6 for receiving a centering pin 7, which is not represented in this figure, runs from top to bottom along the axis of rotation 5, and the four fluid openings 4, wherein only one of the fluid openings 4 is visible due to the sectional representation, run perpendicular to the axis of rotation 5.

The at least one drill bit 2 and the at least one limit stop 3 can form a coherent structural unit.

Besides the at least one limit stop 3, the arrangement 1 in FIG. 1 includes the at least one drill bit 2. The at least one drill bit 2 comprises:
a substantially hollow-cylindrical drill bit body 8 and
at least one closure device 10, in particular an end cap, arranged toward one, in this embodiment the other, end of the at least one drill bit 2 and
a drill bit receiving device 11 arranged toward one, in this embodiment the other, end of the at least one drill bit 2, wherein the drill bit receiving device 11 has
   a fitting mechanism 12 for making contact with a fitting tool, in this embodiment an angular portion, specifically in this embodiment a hexagon head, and
   a drill bit fastening mechanism 13 for fastening the drill bit 2 to a drilling machine 16, preferably to a drive shaft of a drilling machine 16, wherein in this embodiment, for fastening the drill bit 2 to a drilling machine 16, the drill bit fastening mechanism 13 is a thread, specifically in this embodiment an internal thread.

The individual components can be assembled to form a component assembly. This means specifically that, in the arrangement 1, the at least one drill bit 2 can consist of a multi-part component assembly, wherein the component assembly can be detachably and/or non-detachably connected to the at least one drill bit 2, and the at least one limit stop 3 can be designed as a constituent of the drill bit receiving device 11.

The hollow-cylindrical drill bit body 8 and the closure device can be non-detachably connected to one another via a welded seam, thus via a material-bonded connection, as can be identified on the right-hand side of FIG. 1 with the aid of the non-sectional representation of the arrangement 1.

The drill bit receiving device 11 can be inserted into the closure device 10. The exact fit can result in a positive-locking and friction-locking connection between the closure device 10 and the drill bit receiving device 11.

It is conceivable that, besides the embodiment of the arrangement 1 described in FIG. 1, other preferred embodiments can also be provided, wherein the at least one drill bit 2 and/or the at least one limit stop 3 consist and/or consists of one component and/or of a multi-part component assembly, wherein the component assembly can be connected detachably and/or non-detachably.

In FIG. 1 it is indicated by two break lines through the hollow-cylindrical drill bit body 8 that the hollow-cylindrical drill bit body 8 can also have a proportionally greater length.

The length and also all dimensions, such as for example diameters, widths, material thicknesses of the arrangement 1, preferably of the hollow-cylindrical drill bit body 3, can be selected as desired and are in no way limited.

FIG. 2 shows a top view of the arrangement 1 from FIG. 1, comprising the drill bit 2 and the limit stop 3.

In the top view in FIG. 2, the outer contour of the hollow-cylindrical drill bit body 5 and of the closure device 10 can be identified on the outermost edge. The drill bit receiving device 11 can be identified inside these two outer contours. As can already be seen in FIG. 1, the drill bit receiving device 11 has a fitting mechanism 12, wherein in this embodiment the fitting mechanism 12 is a hexagon head.

The hollow-cylindrical drill bit body 8, the closure device 10 and the drill bit receiving device 11 can share a common central through-hole 6.

In a preferred embodiment it can be provided that the central through-hole 6, for receiving a centering pin 7, not represented here, of the at least one limit stop 3 is concentric with the axis of rotation 5 of the at least one drill bit 2.

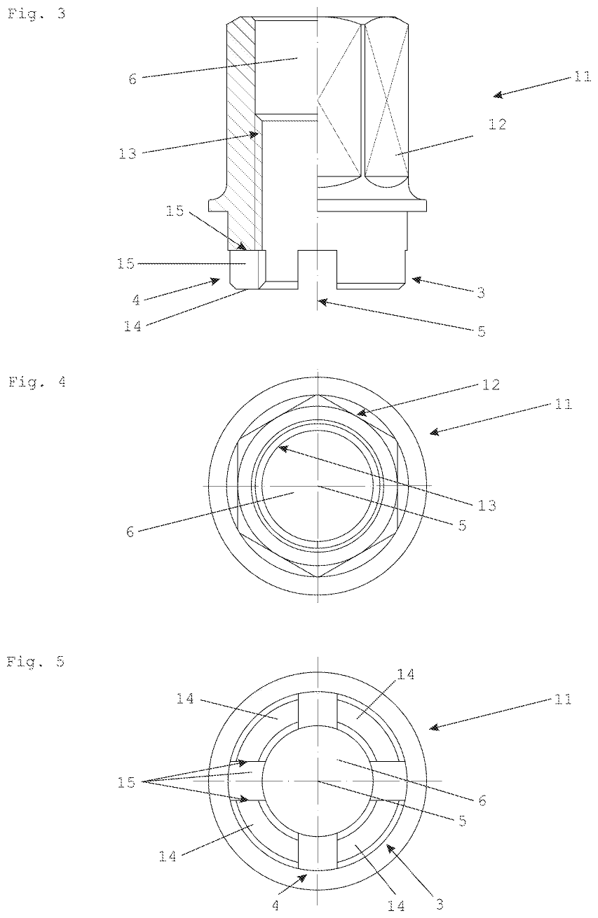

FIG. 3 shows the drill bit receiving device 11 with the limit stop 3 from FIG. 1.

Half of the representation in FIG. 3 is depicted as a sectional representation with a section plane running through the middle of the drill bit receiving device 11 and the other half is depicted as a normal, non-sectional representation.

The drill bit receiving device 11 can have a limit stop 3, a central through-hole 6, a fitting mechanism 12 and a drill bit fastening mechanism 13.

The limit stop 3 can have part of the central through-hole 6, four fluid openings 4, four limit stop surfaces 14 and twelve contour surfaces 15 delimiting the fluid openings 4.

In the sectional representation in FIG. 3, only one of the four fluid openings 4 and only two of the twelve contour surfaces delimiting the fluid openings 4 can be seen, wherein the two contour surfaces 15 visible in FIG. 3 are perpendicular to one another and delimit the one fluid opening 4 visible in FIG. 3 on two sides.

The central through-hole 6 can extend along the axis of rotation 5 from one end of the drill bit receiving device 11, at which the limit stop 3 is arranged, over a portion with the drill bit fastening mechanism 13 as far as the other end of the drill bit receiving device 11.

As can be seen in this embodiment with the aid of the non-sectional representation depicted on the right-hand side in FIG. 3, the fitting mechanism 12 is a hexagon head.

As can be seen in this embodiment with the aid of the sectional representation depicted on the left-hand side in FIG. 3, the drill bit fastening mechanism 13 is an internal thread.

The drill bit receiving device 11 can consist of one component.

It is conceivable that, besides the embodiment of the drill bit receiving device 11 described in FIG. 3, other preferred embodiments can also be provided, wherein the at least one limit stop 3 consists of one component or of a multi-part component assembly, wherein the component assembly can be connected detachably and/or non-detachably.

FIG. 4 shows a top view of the drill bit receiving device 11 with a limit stop 3 from FIG. 3.

The drill bit receiving device 11 can have a hexagonal contour, which can represent the fitting mechanism 12. In FIG. 4, the fitting mechanism 12 is a hexagon head.

The drill bit receiving device 11 can have a round inner contour, which can represent the drill bit fastening mechanism 13. In FIG. 4, the drill bit fastening mechanism 13 is an internal thread.

An arrangement 1 can be fitted with the help of the drill bit receiving device 11, in particular with the help of the fitting mechanism 12 and the drill bit fastening mechanism 13. The drill bit receiving device 11 and/or an arrangement 1 can be fastened to a drilling machine 16, preferably to a drive shaft of a drilling machine 16, with the help of the drill bit receiving device 11 by screwing the drill bit fastening mechanism 13 designed as an internal thread onto an external thread of a drive shaft of a drilling machine 16. In order to screw the drill bit receiving device 11 and/or an arrangement tight with the help of the drill bit receiving device 11, the fitting mechanism 12 designed as a hexagon head can be tightened by hand or by means of a tool wrench.

The fitting mechanism 12 and the drill bit fastening mechanism 13 are not limited to the embodiments shown here but can adopt any desired size and shape.

The central through-hole 6, which can run along the axis of rotation 5 and be suitable for receiving a centering pin 7, not represented here, can be concentric with the axis of rotation 5 of the fitting mechanism 12 and the drill bit fastening mechanism 13.

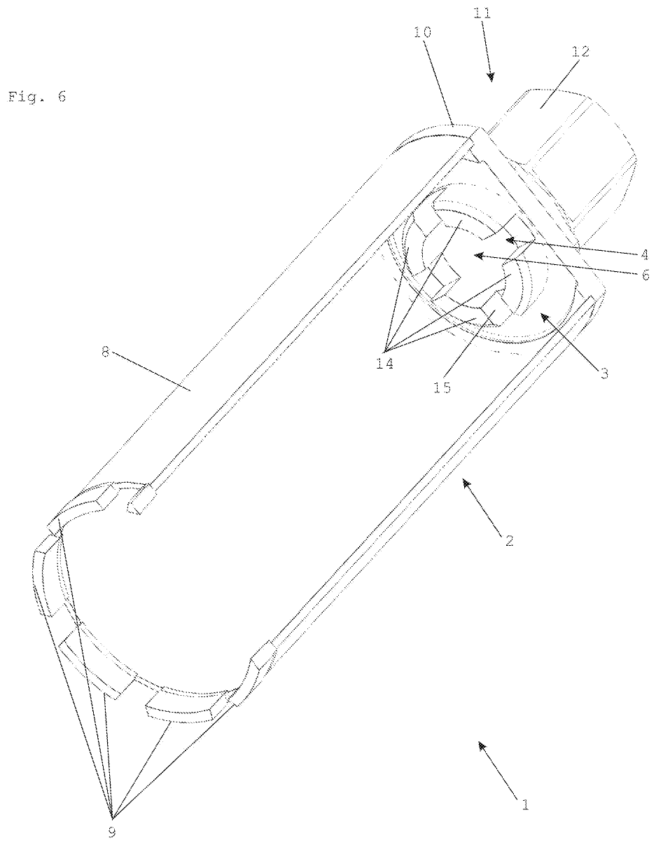

FIG. 5 shows a bottom view of the drill bit receiving device 11 with a limit stop 3 from FIG. 3.

The limit stop 3 can have a central through-hole 6, a hollow-cylindrical basic structure, four fluid openings 4, four limit stop surfaces 14 and twelve contour surfaces 15 delimiting the fluid openings 4.

The cylindrical void volume formed by the limit stop 3 can be a portion of the central through-hole 6.

The four outwardly running fluid openings 4 can extend starting from the portion of the central through-hole 6 formed by the limit stop 3.

The course of the four fluid openings 4 can be directed at right angles to the axis of rotation 5. In other words, it can be provided that the at least one fluid opening 4 is arranged substantially perpendicular to the axis of rotation 5 of the at least one drill bit 2.

In another preferred embodiment, the at least one fluid opening 4 can also adopt any other course and is not restricted to the course represented here. For example, the at least one fluid opening 4 can be aligned running past the axis of rotation 5 and/or partially curved and/or partially straight.

The shape of the four fluid openings 4 can substantially be a cuboid.

The substantially cuboid fluid openings 4 can connect the outer contour to the inner contour of the limit stop 3. In other words, the at least one fluid opening 4 can be a fluid-conducting connection, a fluid connection, between the outside and the inside of the substantially hollow-cylindrical limit stop 3.

The four fluid openings 4 can each be delimited by three contour surfaces 15 of the limit stop 3. The in each case three matching contour surfaces 15 of an individual fluid opening 4 can form a channel, closed off on three sides, with a rectangular cross section.

In the representation in FIG. 5 it can be identified that in each case one of the fluid openings 4 delimited by three contour surfaces 15 runs towards the right, downwards, towards the left and upwards, starting from the axis of rotation 5.

In the case of a broken-off drilling core 22, or parts of a drilling core 22, in the course of drilling, the rectangular cross section of the respective fluid openings 4 can be delimited on four sides. In the process, the respective three contour surfaces 15 of the limit stop 3 can delimit the four-sided and rectangular cross section of one of the four fluid openings 4 on three sides. The last side of the four-sided and rectangular cross section of one of the four fluid openings 4 can be delimited by the drilling core 22, or parts of the drilling core 22, forming in the course of the drilling. In such a case, a fluid opening 4 can continue to be a fluid-conducting connection, a fluid connection, between the outside and the inside of the limit stop 3.

The shape and number of the fluid openings 4 and of the contour surfaces 15 are not restricted to the embodiments represented here.

Any desired number of fluid openings 4 can be provided. In a preferred embodiment it can be provided that at least one fluid opening 4 or two fluid openings 4 or four fluid openings 4 or several fluid openings 4 is or are provided.

Differently shaped fluid openings 4 can be provided. In a preferred embodiment it can be provided that the at least one fluid opening 4 has a round and/or an angular cross section and is delimited by at least one contour surface 15 of the at least one limit stop 3.

In a preferred embodiment, the at least one fluid opening 4 can be a hole, preferably a drilled hole, through the at least one limit stop 3, wherein a cylindrical contour surface 15 of the at least one limit stop 3 can delimit the at least one fluid opening 4.

Four limit stop surfaces 14 can be provided, wherein the four limit stop surfaces 14 can be equally sized circular ring sections.

One or more limit stop surfaces 14 can be delimited along the surface perimeter by a chamfer.

In another preferred embodiment the limit stop 3 can have at least one limit stop point and/or at least one limit stop line instead of or in addition to at least one limit stop surface 14.

The combinations of at least one limit stop point and/or at least one limit stop line and/or at least one limit stop surface 14 are unlimited. It can be provided, for example, that two limit stop lines and three limit stop surfaces 14 or three limit stop points and three limit stop lines or one limit stop point and four limit stop surfaces 14 are provided.

The number and the individual shapes of the at least one limit stop point and/or the at least one limit stop line and/or the at least one limit stop surface 14 are unlimited here and not restricted by the embodiments represented here.

In a particularly preferred embodiment it can be provided that the at least one limit stop 3 has at least one limit stop point and/or at least one limit stop line and/or at least one limit stop surface 14, preferably at least two limit stop surfaces 14, particularly preferably exactly four limit stop surfaces 14, preferably wherein the at least one limit stop line and/or the at least one limit stop surface 14 are aligned transverse to an axis of rotation 5 of the at least one drill bit 2, particularly preferably wherein the at least one limit stop line and/or the at least one limit stop surface 14 are aligned substantially perpendicular to an axis of rotation 5 of the at least one drill bit 2.

The at least one limit stop point and/or the at least one limit stop line and/or the at least one limit stop surface 14 can delimit the limit stop 3 at one end of the limit stop 3 along the axis of rotation 5.

The at least one limit stop point and/or the at least one limit stop line and/or the at least one limit stop surface 14 can represent a site, as far as which a drilling core 22, or parts of a drilling core 22, forming in the course of drilling can move. In other words, the at least one limit stop point and/or the at least one limit stop line and/or the at least one limit stop surface 14 can be an end point of a movement path of a drilling core 22, or parts of a drilling core 22, forming in the course of drilling.

FIG. 6 shows a perspective view of the arrangement 1 from FIG. 1, comprising the drill bit 2 and the limit stop 3.

The view in FIG. 6 is cut off on the right-hand side of the arrangement 1 of the hollow-cylindrical drill bit body 8 and the closure device 10, specifically decentrally along the cutting device 9, in order to depict the void volume of the drill bit 2 and thus the limit stop 3.

FIG. 6 shows an arrangement 1 composed of at least one drill bit 2 and at least one limit stop 3 for a drilling core 22, or parts of a drilling core 22, forming in the course of drilling, wherein the at least one limit stop 3 has at least one fluid opening 4 transverse to an axis of rotation 5, which is not represented in FIG. 6, of the at least one drill bit 2, wherein the at least one limit stop 3 has a central through-hole 6 for receiving a centering pin 7.

Besides the at least one limit stop 3, the arrangement 1 in FIG. 6 includes the at least one drill bit 2. The at least one drill bit 2 comprises:
a substantially hollow-cylindrical drill bit body 8 and
at least one cutting device 9 arranged at one end of the at least one drill bit 2 and
at least one closure device 10, in particular an end cap, arranged toward one, preferably the other, end of the at least one drill bit 2 and
a drill bit receiving device 11 arranged toward one, preferably the other, end of the at least one drill bit 2, wherein the drill bit receiving device 11 has
   a fitting mechanism 12 for making contact with a fitting tool, preferably an angular portion, particularly preferably a hexagon head, and/or
   a drill bit fastening mechanism 13 for fastening the drill bit 2 to a drilling machine 16, preferably to a drive shaft of a drilling machine 16, preferably wherein, for fastening the drill bit 2 to a drilling machine 16, the drill bit fastening mechanism 13 is a thread, particularly preferably an internal thread.

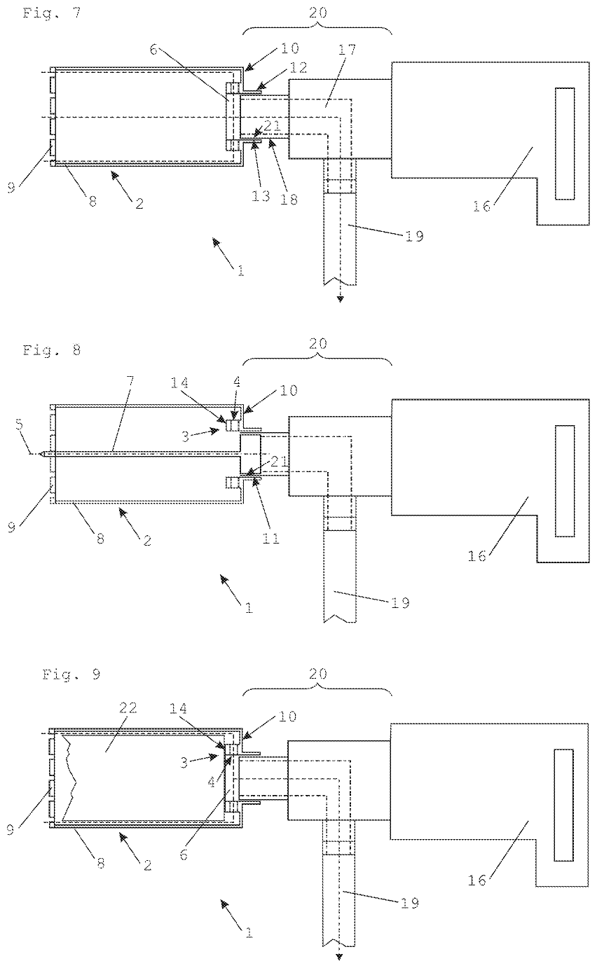

FIG. 7 shows a schematic representation of a drilling machine 16 with an arrangement 1 according to the invention.

The drilling machine 16 can be designed in such a way that the drilling machine 16 is equipped with at least one fluid-conducting portion 17, preferably at least one air-suction portion, at least one arrangement 1 according to the first and/or second aspect according to the invention, and a drilling machine fastening mechanism 18 for fastening the drill bit 2 or the arrangement 1 to the drilling machine 16. Preferably, it can further be provided that the drill bit 2 has a drill bit fastening mechanism 13 and the drilling machine fastening mechanism 18 of the drilling machine 16 has a counter-fastening mechanism, corresponding to the drill bit fastening mechanism 13 of the drill bit 2, which is preferably formed as an external thread.

The at least one fluid-conducting portion 17, preferably the at least one air-suction portion, can be in or can be brought into a fluid connection with a connector 19 for a suction device.

The at least one fluid-conducting portion 17, preferably the at least one air-suction portion, and/or the drilling machine fastening mechanism 18 can be formed in and/or on a drill adaptor 20 that can preferably be detachably connected to the drilling machine 16.

In FIG. 7 it can be identified with the aid of the dashed lines that air can be sucked in through the whole void volume of the drill bit 2 and can be conducted further through the fluid-conducting portion 17.

FIG. 8 shows a schematic representation of the drilling machine 16 from FIG. 7 with a centering pin 7.

A fixing mechanism 21 for detachably fixing a further part, preferably a centering pin 7 or a drill, particularly preferably a center drill, can be provided on the drilling machine 16, preferably wherein the fixing mechanism 21 is formed for detachably fixing a further part in and/or on a drill adaptor 20 that can preferably be detachably connected to the drilling machine 16, and preferably wherein the fixing mechanism 21 has an internal thread.

FIG. 9 shows a schematic representation of a drilling machine 16 from FIG. 7 with a drilling core 22 forming in the course of drilling.

The at least one fluid opening 4 can be formed as a fluid connection, preferably a gas connection, between the drill bit 2 and the at least one fluid-conducting portion 17, preferably the at least one air-suction portion.

The fluid connection between the drill bit 2 and the at least one fluid-conducting portion 17, preferably the at least one air-suction portion, can be retained even when a drilling core 22 forming due to drilling closes the central through-hole 6 since the fluid connection can persist through the fluid openings 4.

In FIG. 9 it can be identified with the aid of the dashed lines that air can be sucked in through a void volume of the drill bit 2 which is not filled by a broken-off drilling core 22 and can be conducted further, via the at least one fluid opening 4, to the fluid-conducting portion 17.

With the aid of FIGS. 7 to 8, a method can be described in which in a first step a partial drilling can be performed with the arrangement 1 and a centering pin 7 from FIG. 8 and in a second step, after the centering pin has been removed, the partial drilling can be continued with the arrangement 1 from FIG. 7. Even if a drilling core 22, or parts of a drilling core 22, forming in the course of the partial drilling closes and/or close the central through-hole 6 when the partial drilling is continued, as represented in FIG. 9, a fluid connection can continue to be maintained via the at least one fluid opening 4.

In other words, a method for machining a workpiece by means of at least one arrangement 1 according to the first and/or the second aspect according to the invention can be carried out, in which
the at least one limit stop 3 has a central through-hole 6 for receiving a centering pin 7, wherein in a first method step a centering pin 7 is arranged in the at least one through-hole 6 and a partial drilling of the workpiece is performed, and in a second method step the centering pin 7 is removed and the partial drilling of the workpiece is continued, and/or
the at least one drill bit 2 and the at least one limit stop 3 form a coherent structural unit, wherein the structural unit is detachably fastened to a drive shaft of a drilling machine 16 before and/or after a drilling of the workpiece is carried out.

### LIST OF REFERENCE NUMBERS

1 arrangement
2 drill bit
3 limit stop
4 fluid opening
5 axis of rotation
6 central through-hole
7 centering pin
8 drill bit body
9 cutting device
10 closure device
11 drill bit receiving device
12 fitting mechanism
13 drill bit fastening mechanism
14 limit stop surface
15 contour surface
16 drilling machine
17 fluid-conducting portion
18 drilling machine fastening mechanism
19 connector
20a drill adaptor
21 fixing mechanism
22 drilling core

1. An arrangement comprises at least one drill bit and at least one limit stop for a drilling core, or parts of a drilling core, forming in the course of drilling, wherein the at least one limit stop has at least one fluid opening transverse to an axis of rotation of the at least one drill bit, wherein the at least one limit stop has a central through-hole for receiving a centering pin.

2. The arrangement according to claim 1, wherein the at least one drill bit and the at least one limit stop form a coherent structural unit.

3. The arrangement according to claim 1, wherein the at least one drill bit comprises:
a substantially hollow-cylindrical drill bit body and/or
at least one cutting device arranged at one end of the at least one drill bit and/or
at least one closure device, in particular an end cap, arranged toward one, preferably the other, end of the at least one drill bit and/or
a drill bit receiving device arranged toward one, preferably the other, end of the at least one drill bit, wherein the drill bit receiving device has
a fitting mechanism for making contact with a fitting tool, preferably an angular portion, particularly preferably a hexagon head, and/or
a drill bit fastening mechanism for fastening the drill bit to a drilling machine, preferably to a drive shaft of a drilling machine, preferably wherein, for fastening the drill bit to a drilling machine, the drill bit fastening mechanism is a thread, particularly preferably an internal thread.

4. An arrangement according to claim 1, wherein the at least one drill bit and/or the at least one limit stop consist and/or consists of one component and/or of a multi-part component assembly, wherein the component assembly can be connected detachably and/or non-detachably.

5. The arrangement according to claim 1, wherein the at least one limit stop has at least one limit stop point and/or at least one limit stop line and/or at least one limit stop surface, preferably at least two limit stop surfaces, particularly preferably exactly four limit stop surfaces, preferably wherein the at least one limit stop line and/or the at least one limit stop surface are aligned transverse to an axis of rotation of the at least one drill bit, particularly preferably wherein the at least one limit stop line and/or the at least one limit stop surface are aligned substantially perpendicular to an axis of rotation of the at least one drill bit.

6. The arrangement according to claim 1, wherein the at least one fluid opening is arranged substantially perpendicular to the axis of rotation of the at least one drill bit.

7. The arrangement according to claim 1, wherein the at least one fluid opening has a round and/or an angular cross section and is delimited by at least one contour surface of the at least one limit stop.

8. The arrangement according to claim 1, wherein the central through-hole, for receiving a centering pin, of the at least one limit stop is concentric with the axis of rotation of the at least one drill bit.

9. A drilling machine comprising a fluid-conducting portion, an air-suction portion, the arrangement according to claim 1, and a drilling machine fastening mechanism for fastening the drill bit or the arrangement to the drilling machine, preferably wherein the drill bit has a drill bit fastening mechanism and the drilling machine fastening mechanism of the drilling machine has a counter-fastening mechanism, corresponding to the drill bit fastening mechanism of the drill bit, which is preferably formed as an external thread.

10. The drilling machine according to claim 9, wherein the at least one fluid-conducting portion, preferably the at least one air-suction portion, is in or can be brought into a fluid connection with a connector for a suction device.

11. The drilling machine according to claim 9, wherein the at least one fluid-conducting portion, preferably the at least one air-suction portion, and/or the drilling machine fastening mechanism are formed in and/or on a drill adaptor that can preferably be detachably connected to the drilling machine.

12. The drilling machine according to claim 9, wherein a fixing mechanism for detachably fixing a further part, preferably a centering pin or a drill, particularly preferably a center drill, is provided on the drilling machine, preferably wherein the fixing mechanism is formed for detachably fixing a further part in and/or on a drill adaptor that can preferably be detachably connected to the drilling machine, and preferably wherein the fixing mechanism has an internal thread.

13. The drilling machine according to claim 9, wherein the at least one fluid opening is formed as a fluid connection, preferably a gas connection, between the drill bit and the at least one fluid-conducting portion, preferably the at least one air-suction portion.

14. A method for machining a workpiece the arrangement according to claim 1, wherein:
the at least one limit stop has a central through-hole for receiving a centering pin, wherein in a first method step a centering pin is arranged in the at least one through-hole and a partial drilling of the workpiece is performed, and in a second method step the centering pin is removed and the partial drilling of the workpiece is continued, and/or
the at least one drill bit and the at least one limit stop form a coherent structural unit, wherein the structural unit is detachably fastened to a drive shaft of a drilling machine before and/or after a drilling of the workpiece is carried out.
